(19) United States
(12) Patent Application Publication
(10) Pub. No.: US 2007/0014128 A1
(43) Pub. Date: Jan. 18, 2007

(54) Plug-in lamp

(75) Inventor: Gang Chen, Shenzhen (CN)

Correspondence Address: Mr. Eric Chan, 42 Pin Oaks Drive, Phoenixville, PA, 19460, US

(73) Assignees: CE Lighting Ltd., Shenzhen (CN); Landlite Light Fixtures Mfg. Co. Ltd., Shenzhen (CN); Landlite Lighting Mfg. Co. Ltd., Shenzhen (CN)

(21) Appl. No.: 11/336,772

(22) Filed: Jan. 23, 2006

(30) Foreign Application Priority Data
Jul. 15, 2005 (CN) 200520111811.5
Oct. 5, 2005 (CN) 200520128661.9

(51) Int. Cl. H01R 33/00

(52) U.S. Cl. 362/652

(57) ABSTRACT

A plug-in lamp includes a plug-in lamp cap, a lamp tube combined to the lamp cap, and a lamp shade enclosing the lamp tube. The plug-in lamp cap can only fit a plug-in lamp holder and cannot fit a standard incandescent lamp holder which can hold a standard incandescent lamp with a screw lamp cap or bayonet lamp cap. The plug-in lamp may be an energy-saving lamp, a fluorescence lamp and so on.

### FIELD OF THE INVENTION

This invention relates to a lamp, and particularly to a plug-in lamp.

### BACKGROUND OF THE INVENTION

Because of the need to save energy, several attempts at developing replacement lamps with energy-saving effect for replacing incandescent lamps have been made. However, conventional lamps with energy-saving effect, such as energy-saving lamps or fluorescence lamps, adopt screw lamp caps or bayonet lamp caps which can fit standard incandescent lamp holders. That is, a lamp holder for a lamp with energy-saving effect can also be used to hold a standard incandescent lamp. Thus, when a lamp with energy-saving effect needs to be replaced, the user may choose an incandescent lamp for replacement since the lamp holder for the lamp with energy-saving effect can also fit the incandescent lamp. The using of the incandescent lamps breaches the intent of saving energy.

Accordingly, there is a need to provide an improved lamp which overcomes the above mentioned shortcoming.

### SUMMARY OF THE INVENTION

The primary objective of this invention is to provide a plug-in lamp which cannot fit lamp holders for standard incandescent lamps.

A plug-in lamp in accordance with the present invention comprises a plug-in lamp cap, a lamp tube combined to the lamp cap, and a lamp shade surrounding the lamp tube. The plug-in lamp cap can only fit a plug-in lamp holder and cannot fit a standard incandescent lamp holder which can hold a standard incandescent lamp with a screw lamp cap or bayonet lamp cap. The plug-in lamp of the present invention is a lamp with energy-saving effect, such as an energy-saving lamp or a fluorescence lamp. When a combination of a plug-in lamp of the present invention and a plug-in lamp holder is chosen by a user and the plug-in lamp needs to be replaced, no incandescence lamp can be used to replace the plug-in lamp since the plug-in lamp holder cannot fit standard incandescence lamps which adopt screw lamp caps or bayonet lamp caps. The chance to use incandescence lamps is reduced and the chance to use lamps with energy-saving effect is correspondingly increased.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 is an exploded view of a lamp in accordance with a preferred embodiment of the present invention;

FIG. 2 is a plan view of the lamp of FIG. 1 with a lamp shade in a cross-section way;

FIG. 3 is an assembled view of the lamp of FIG. 1;

FIG. 4 shows a part cutaway section of a lamp in an alternative embodiment of this invention; and

FIG. 5 is a perspective view of the lamp of FIG. 4.

### DETAILED DESCRIPTION OF THE INVENTION

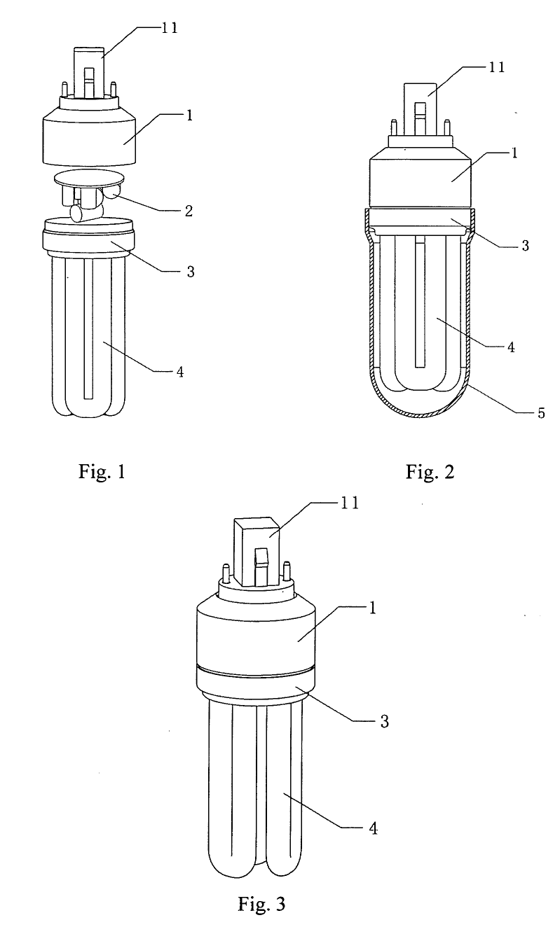

As shown in FIGS. 1-3, a plug-in lamp in accordance with a preferred embodiment of the invention is an energy-saving lamp. The lamp comprises an upper shell 1 and a lower shell 3 combined to the upper shell 1 to form a receiving space. A circuit board 2 with some circuits and electrodes disposed inside is accommodated within the receiving space. A lamp tube 4 is engaged to the lower shell 3 and electrically connected to the circuit board 2.

A plug-in lamp cap 11 is mounted to the upper lamp shell 1. The lamp cap 11 has a pair of barbs at two sides thereof to cause the plug-in energy-saving lamp of the present invention only to fit plug-in lamp holders. Thus, when a combination of a plug-in energy-saving lamp of the present invention and a plug-in lamp holder is chosen by a user and the plug-in energy-saving lamp needs to be replaced, no incandescence lamp can be used to replace the plug-in energy-saving lamp since the plug-in lamp holder cannot fit standard incandescence lamps which adopt screw lamp caps or bayonet lamp caps. The chance to use incandescence lamps is reduced and the chance to use the energy-saving lamps is correspondingly increased. In the preferred embodiment of the present invention, the model of the lamp cap 11 can be G23, G24, 2G7, 2G11, 2G10, 2GX13, GX23 or GX24 which can only fit lamp holders of G23, G24, 2G7, 2G11, 2G10, 2GX13, GX23 or GX24 respectively.

As shown in FIG. 2, a lamp shade 5 is attached to the lower lamp shell 3 and encloses the lamp tube 4 for beautifying the energy-saving lamp.

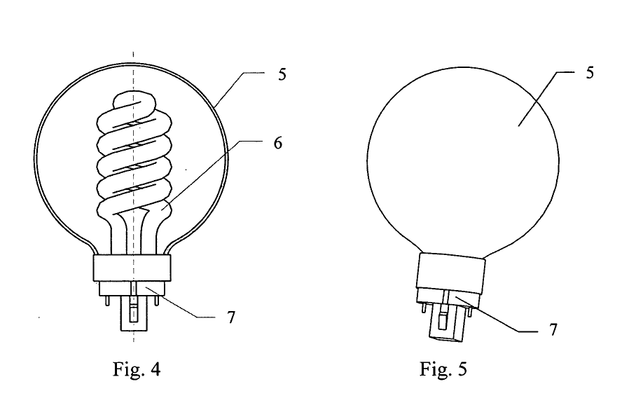

Alternatively, as shown in FIGS. 4-5, the lamp of the present invention can be a fluorescence lamp. The fluorescence lamp comprises a lamp cap 7, a fluorescence lamp tube 6 and a lamp shade 5 enclosing the fluorescence lamp tube 6.

As the lamp cap 11 described above, the lamp cap 7 of the alternative embodiment of the present invention is plug-in type and can only fit plug-in lamp holders. The model of the lamp cap 7 can be G23, G24, 2G7, 2G11, 2G10, 2GX13, GX23 or GX24 which can only fit lamp holders of G23, G24, 2G7, 2G11, 2G10, 2GX13, GX23 or GX24 respectively.

The fluorescence lamp tube 6 is single-capped and fixedly combined to the lamp cap 7 via adhesive means. Alternatively, the fluorescence lamp tube 6 may be detachably mounted to the lamp cap 7 by other means, such as insertion means. The fluorescence lamp tube 6 is spiral-shaped. Alternatively, the fluorescence lamp tube 6 may also be linear-shaped or syphon-shaped.

The lamp shade 5 is detachably or fixedly attached to the lamp cap 7. The lamp shade 5 is G-shaped. Alternatively, the lamp shade 5 may be trump-shaped, ball-shaped, pyramid-shaped, tubular-shaped, A-shaped, B-shaped, CA-shaped, CM-shaped, F-shaped, PS-shaped, R-shaped, S-shaped, T-shaped and so on. The lamp shade 5 is made of glass, plastic, paper, cloth, bine and so on. The lamp shade 5 may be close or open.

In the alternative embodiment of the present invention, circuits (not shown) for the fluorescence lamp are arranged outside and not incorporated in the fluorescence lamp. Thus, when the lamp tube 6 is broken and needs to be replaced, the circuits for the lamp need not to be replaced since the lamp tube 6 and the circuits are separable.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A lamp comprising:
a plug-in lamp cap adapted for fitting a plug-in lamp holder; and
a lamp tube combined to the lamp cap for emitting light rays.

2. The lamp as claimed in claim 1, further comprising an upper shell to which the plug-in lamp cap is mounted, a lower shell combined to the upper shell to form a receiving space, and a circuit board accommodated within the receiving space.

3. The lamp as claimed in claim 1, further comprising a lamp shade surrounding the lamp tube.

4. The lamp as claimed in claim 3, wherein the lamp shade is made of one of glass, plastic, paper, cloth and bine.

5. The lamp as claimed in claim 3, wherein the lamp shade has one of trump shape, ball shape, pyramid shape, tubular shape, A shape, B shape, CA shape, CM shape, F shape, PS shape, R shape, S shape and T shape.

6. The lamp as claimed in claim 3, wherein the lamp shade is detachably or fixedly attached to the plug-in lamp cap.

7. The lamp as claimed in claim 3, wherein the lamp shade is close or open.

8. The lamp as claimed in claim 1, wherein the model of the plug-in lamp cap is one of G23, G24, 2G7, 2G11, 2G10, 2GX13, GX23 and GX24.

9. The lamp as claimed in claim 1, wherein the lamp tube has one of spiral shape, linear shape and syphon shape.

10. The lamp as claimed in claim 1, wherein the lamp tube is fixedly combined to the lamp cap via adhesive means.

11. The lamp as claimed in claim 1, wherein the lamp tube is detachably combined to the lamp cap via insertion means.

12. The lamp as claimed in claim 1, wherein the lamp tube is a single-capped fluorescence lamp tube.

13. The lamp as claimed in claim 12, wherein circuits for the lamp are arranged outside of the lamp and are separable from the fluorescence lamp tube.
